(19) United States
(12) Patent Application Publication
(10) Pub. No.: US 2006/0156397 A1
(43) Pub. Date: Jul. 13, 2006

(54) A New Anti-spy method without using scan

(75) Inventor: Steven Dai, Astoria, NY (US)

Correspondence Address: STEVEN DAI, 2427 STEINWAY ST., APT. #11, ASTORIA, NY, 11103, US

(73) Assignee: Steven Dai, Astoria, NY (US)

(21) Appl. No.: 10/905,632

(22) Filed: Jan. 13, 2005

(51) Int. Cl. G06F 12/14; H04L 9/32; G06F 11/00; G06F 11/30; G06F 11/22; G06F 11/32; G06F 11/34; G06F 11/36; G06F 12/16; G06F 15/18; G08B 23/00

(52) U.S. Cl. 726/22; 713/188; 726/24

(57) ABSTRACT

Various known ways to make a Spyware are analyzed and countered. Spy-ware works by replacing the function address/value/body of certain Windows APIs with its own spying code. The Anti-spy invention counters it by replacing the tainted APIs with clean ones through reconstruction. This process is repeated periodically. Although the techniques illustrated here are applied on Microsoft Windows platform, the methodology can be used in other platforms as well.

### FIELD OF THE INVENTION

This invention relates generally to protecting users from spy programs in real time without using conventional scanning method.

### BACKGROUND OF THE INVENTION

Spy software (“Spyware”) can detect and record what the user is typing and use this information in a hostile way. There are several known ways to make a Spyware. The purpose of this invention is to analyze each and to counter each in return. The invention is particularly useful for Microsoft's Internet Explorer users who may enter a password to access their online accounts. The invention assures that the user data, such as userid and password, are protected from Spyware as long as a user turns on the Anti-spy feature.

Most currently known Anti-spy wares are scan based, that is, the program contains a database of all known Spywares to its knowledge and searches the user's hard drive to see if it contains the signature of the Spyware identified by the database. If it does, remove the Spyware. The drawback of this approach is that if the Spyware is not known to the database, like a new or less known one, it won't be able to detect it. For example, the invention claimer downloaded several Spywares for testing purposes, but two of most popular Anti-spy software detected none of them.

There are few non-scan-based Anti-spy wares available on the market. However, they are not as fine-grained as the one in this claim which uses function address/value reconstruction and limits the method to a few critical APIs.

This invention concentrates on the user level Spyware. Its methodology, however, can be applied to kernel level as well.

### BRIEF SUMMARY OF THE INVENTION

The above mentioned shortcoming of the convention scanning method is addressed by the present invention, which will be understood by reading and studying the following specification.

There are several known ways to create a user level Spyware, including modifying the Import or Export tables in the PE file, modifying function value, modifying function body, and sending Spy messages to the Spying application.

The invention counters each Spying method by reversing its effect. Only a limited number of drawing and messaging APIs and Windows network APIs are affected. In addition, it does so periodically to counter the situation where a spy ware comes in after invoking the Anti-spy procedure. The invention can be particularly aimed at the Internet Explorer where users feel most unsecured. As the result, it greatly simplifies and reduces the scope of the Anti-spying process.

### BRIEF DESCRIPTION OF THE DRAWINGS

FIG. 1 is a block diagram illustrating typical Spyware, in accordance with the prior art;

FIG. 2 is a block diagram illustrating a first method of Anti-Spyware, in accordance with a preferred embodiment of the present invention;

FIG. 2 is a block diagram illustrating a first method of Anti-Spyware, in accordance with a preferred embodiment of the present invention;

FIG. 3 is a block diagram illustrating a second method of Anti-Spyware, in accordance with a preferred embodiment of the present invention;

FIG. 4 is a block diagram illustrating a third method of Anti-Spyware, in accordance with a preferred embodiment of the present invention; and

FIG. 5 is a block diagram illustrating a fourth method of Anti-Spyware, in accordance with a preferred embodiment of the present invention.

### DETAILED DESCRIPTION OF THE INVENTION

In the following discussion, the ‘Target” application refers to the running application at which the Spyware is aiming.

There are several known ways to make a Spyware and the corresponding ways to counter each.

When a keyboard input is received, the Target application displays the input by calling certain drawing APIs, DrawTextEx, for example. The function receives the keyboard information and renders it to the screen.

First, some background knowledge on PE file is needed.

PE stands for Portable Executable. The meaning of “portable executable” is that the file format is universal across win32 platform: the PE loader of every win32 platform recognizes and uses this file format even when Windows is running on CPU platforms other than Intel.

The real content of the PE file is divided into blocks called “sections”. A section is nothing more than a block of data with common attributes such as code/data, read/write etc. You can think of a PE file as a logical disk. The PE header is the boot sector and the sections are files in the disk. Sections can contain both code and data provided that they have the same attributes.

A PE file contains an Import and an Export sections. An Import section includes all information on Import functions. An Import function is a function that is not in the caller's module but is called by the module, thus the name “Import”. The Import functions actually reside in one or more DLLs. Only the information about the functions is kept in the caller's module. That information includes the function names and the names of the DLLs in which they reside.

The data structure in the Import section is an array of IMAGE_DATA_DIRECTORY structure which contains two tables:

IMAGE_IMPORT_BY_NAME 22 representing the names of the imported functions, and

IMAGE_THUNK_DATA 24 representing the addresses of the functions. There is one-to-one relationship between the name and address of the function.

When the PE loader runs a program, it loads the associated DLLs into the process address space. It then extracts information about the Import functions from the main program. It uses the information to search the DLLs for the addresses of the functions to be patched into the main program. The place in the DLLs where the PE loader looks for the addresses of the functions is the Export table.

A DLL/EXE exports a function to be used by other DLL/EXE in the Export structure. The Export structure is called IMAGE_EXPORT_DIRECTORY which also contains two tables. IMAGE_EXPORT_BY_NAME 12 keeps the names of the functions and IMAGE_EXPORT_BY_ADDRESS 14 contains the addresses of the functions. There is one-to-one relationship between the name and the address of the function.

Two ways of obtaining a clean version of the function address/value/body in a DLL are discussed next. They are necessary since the DLL can be intercepted and modified by a spy ware as early as the DLL is being loaded.

The first way is to map the original DLL on disk into the process memory in binary format and reconstruct the Import table, Export table and the function values/bodies according to the specification of the PE file.

The second way is to obtain these function address/value/body in a Spyware free environment and hard code them in the Anti-Spy procedure use it later when the application starts normally.

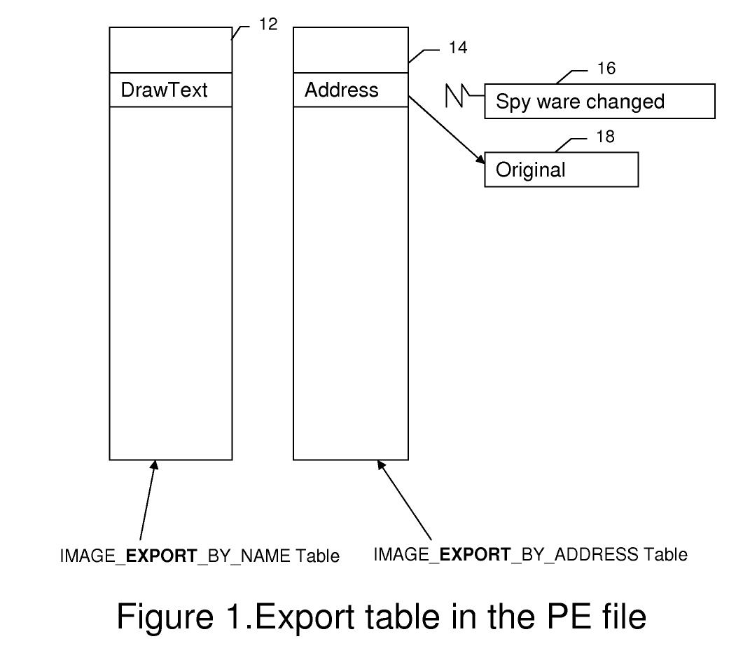

1). As illustrated in FIG. 1, A Spyware can change the function address 18 to the spying address 16 by modifying the Export table so that any call to the function from any module will be directed to the Spy code. This method is also commonly known as “function forwarding”.

Since each DLL has a different base address in the process, it is not possible to recover the function address 18 by simply copying the address over from the new clean version of DLL. However, the difference between the base address of the DLL and the function address should be the same in both DLLs since the order of the functions is fixed. To counter it in this invention, the clean version of the function address 18 in the tainted DLL can be recovered by adding the base address of the tainted DLL to the address difference of the new clean DLL. The address is used to replace the tainted one in the Export table.

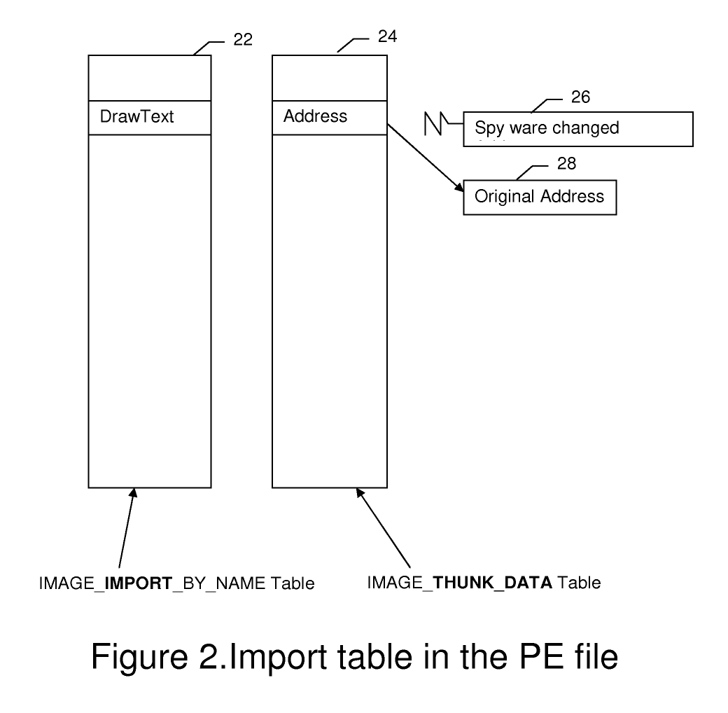

2). As illustrated in FIG. 2, A Spyware can hijack the APIs like DrawTextEx by replacing the function address 28 in the Import tables 22, 24 with its own function address 26 which points to the spying code. By changing this address, it's ensured that all calls to the function in the module will be re-routed to the function interceptor. This replacement is done for all modules which imports the function in the application.

To counter it in this invention, the targeted function addresses 28 are retrieved from the Export table by name. The address in the Export table is the clean one as guaranteed by 2 and can't be affected by changes made by Spyware in the Import tables. This address 28 is used to replace the addresses 26 modified by Spyware in the Import tables of all modules. As the result, the effect of the Spyware is reversed.

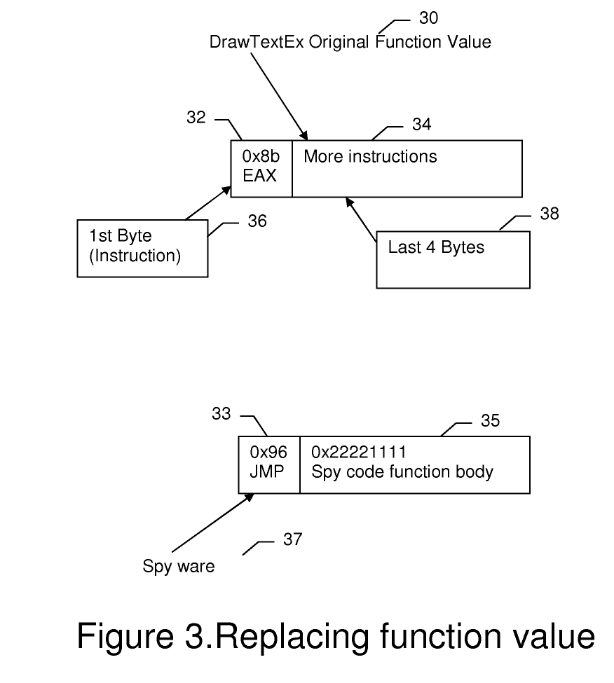

3). As illustrated in FIG. 3, another way to hijack the function DrawTextEx is to change its function value 30. When the application goes to the address defined in the Import table, it executes the function value at the address. The value of the function is an instruction which is 5 bytes long. In the case of DrawTextEx, the first byte 36 of the instruction is ‘EAX’ 32, which means loading the value followed 34 into the register. Spyware works by changing this 5 byte instruction. The instruction is changed to a ‘Jump’ instruction 33, jumping to the address 35 of the spy code 37. Specifically, the first byte of the instruction is changed from ‘EAX’ 32 to ‘JMP’ 33, Jump. After finishing its Spy work, the Spyware jumps back to where it started and the execution of the function resumes as if nothing happened.

This invention counters it by first obtaining a clean version of the function value. Next, when the current application starts, the first byte of the instruction of the function value is checked to see if it equals to ‘JMP’ 33. If so, it means that the instruction has been tampered. To reverse the effect of the Spyware, the previously obtained untainted function value 32, 34 is used to replace the tainted one 33, 35.

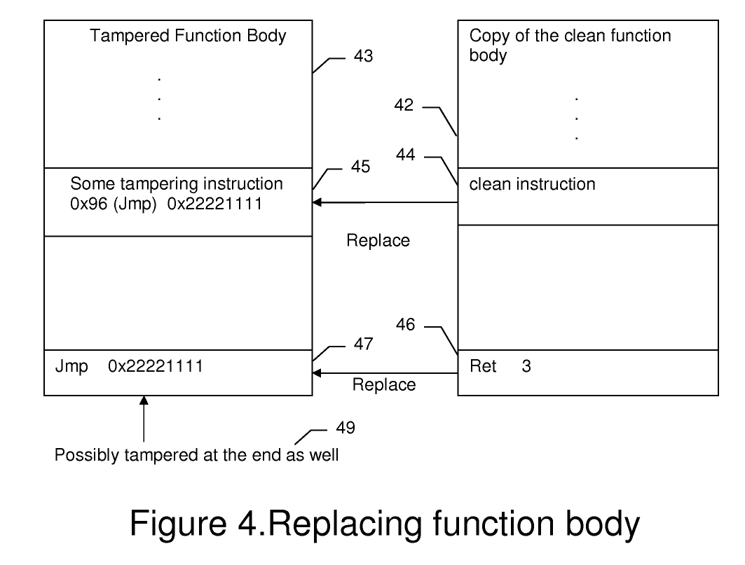

4). As illustrated in FIG. 4, a slightly different approach from the method 3) can be used for spying, that is, replacing part 44, 46 of the function body 42 with Spying code 45, 47 by using ‘JMP’ (Jump) technique as in 3). When the application starts to execute the tainted part 45 of the function body 43, it does a jump 45, 47 to the Spying code 49.

This invention counters it by replacing the changed function body 43 with an untainted one 42. To replace the tainted body 43 with the clean version of the body 42 from the clean DLL, the size and starting address of the function body need to be obtained. The size is calculated through enumerating all the functions in the DLL in descending order and getting the difference between the address of the function and the address of the function next to it. The starting of the body is identified as the function address minus the 5 byte long instruction.

5). The next way to Spy on the user data with the presence of internet connection is to Spy on the Windows network socket API used to transfer data between the user's machine and the intended target machine. The Spying method is the same as those in display function, like DrawText etc, in particular, to spy on the Windows socket API WSASend, or “Send”. The way to counter it is the same as the way of DrawText API.

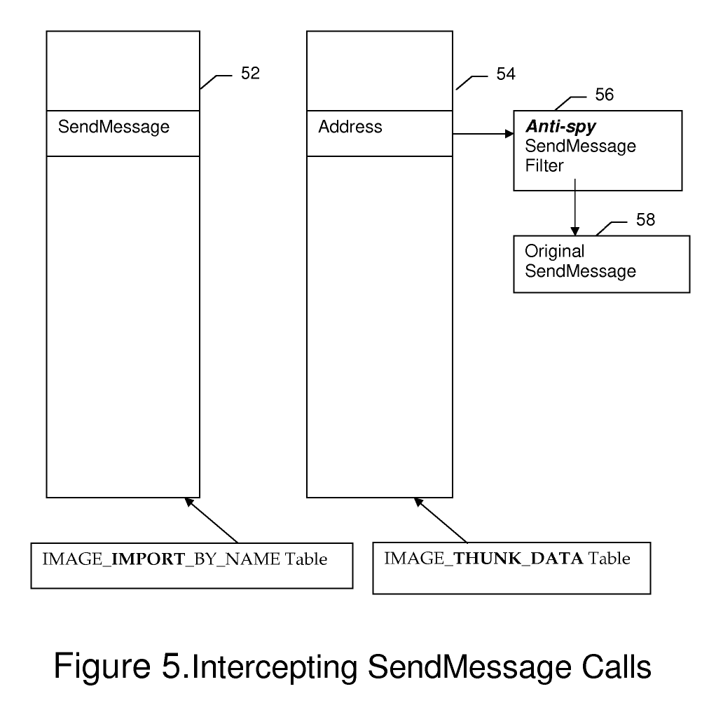

6). As in FIG. 5, the sixth way to spy on the user data is done after the user data, like username and password, are displayed on the screen. The Spy software can call SendMessage to send the Spy messages containing the user data out to the Spying application.

To counter it in this invention, SendMessage function address is replaced with our own version of SendMessage in the import tables 52, 54, much like what the Spyware does in (3. All SendMessage calls are intercepted by the Anti-spy procedure 56, and the Spy messages are filtered out 58.

9). All above Anti-spy procedures are performed periodically to manage the situation where the Spyware starts after the Anti-spy procedures are turned on in which case the spy ware can overwrite the procedures. In this case the Anti-spy procedures are reapplied.

10). The preferred embodiment of the invention is implemented as a BHO (Browser Helper Object) for Microsoft's Internet Explorer or its equivalent in other types of Web browsers. A BHO is a DLL which is registered as an Internet Explorer extension and can be loaded directly into Internet Explorer and activated when the explorer starts. A context menu and a toolbar button are added through BHO where the Anti-spy procedures can be invoked. The Anti-spy feature can be turned on and off by clicking on the context menu or toolbar button.

11). The embroilment of the invention can also be implemented as a standalone application with the Anti-spy feature put into a DLL and loaded into the application. This application runs in the background. When any other applications including Internet Explorer start, Anti-spy DLL is injected into the application using the standard DLL injection techniques. As the result, the Anti-spy procedures can be applied to any applications.

12). The discovery of the tainted function address/value/body can be regarded as the evidence of the presence of a Spyware, especially when the Spyware intends to periodically modify the function parameters. This information can be used as a Spyware detect rule for the regular scan based Anti-spy ware.

Those skilled in the art will recognize that modifications and variations can be made without departing from the spirit of the invention. Therefore, it is intended that this invention encompass all such variations and modifications as fall within the scope of the appended claims.

1-21. (canceled)

22. A computerized method for dynamically protecting users from Spyware, comprising:
obtaining a clean version of an address/value/body for an API function as a clean address/value/body;
detecting that Spyware has created a tainted version of the address/value/body for the API function as a tainted address/value/body; and
replacing the tainted address/value/body with the clean address/value/body in a Portable Executable (PE) file of an application in the run-time.

23. The computerized method in claim 22 wherein:
the API function comprises Microsoft Windows APIs: DrawText, DrawTextEx, TextOut, ExtTextOut, WSASend and send in user mode and their counterparts in kernel mode.

24. The method of claim 22 further comprising:
obtaining the clean address/value/body by mapping an original DLL containing the API function from a hard drive into a processor memory in run time; and
updating import and export tables and reconstructing an address/value/body of the API function according to a specification of a PE file.

25. The method of claim 24 further comprising:
computing a difference between a function address and a base address of a clean version of the a DLL containing the API function; and
obtaining a clean version the API function at a run time by adding the difference to a run time base address of a tainted DLL.

26. The method of claim 22 further comprising:
obtaining the clean address/value/body by hard-coding in an Anti-Spyware with the clean address/value/body obtained in a Spyware free environment.

27. The method of claim 26 further comprising:
computing a difference between a function address and a base address of a clean version of the a DLL containing the API function; and
obtaining a clean version the API function at a run time by adding the difference to a run time base address of a tainted DLL.

28. The method of claim 22 further comprising:
protecting users from Spyware which changes an address of the API function by:
detecting a change in the address of the API function to identify a tainted function address in an export table in a PE file; and
replacing the tainted function address in the export table in the PE file with a clean version of the address of the API function.

29. The method of claim 22 further comprising:
protecting users from Spyware which changes an address of the API function by:
detecting a change in the address of the API function to identify a tainted function address in an import table in a PE file; and
replacing the tainted function address in the import table in the PE file with a clean version of the address of the API function.

30. The method of claim 22 further comprises:
protecting users from Spyware which changes a first instruction of a function value with a Jump instruction for jumping to a spying code by:
detecting a change in the first instruction of the function value to identify a tainted function value; and
replacing the tainted function value with a clean version of the function value.

31. The method of claim 22 further comprising:
protecting users from Spyware which changes a function body by:
enumerating a set of function addresses in a clean version of a DLL in descending order to identify a target function and a function next to it;
computing an address difference between the target function and the function next to it to determine a function body size;
identifying a clean version of the function body by using the function address as a beginning of the clean version of the DLL; and
replacing a tainted version of the function body with a clean version of the function body by copying a number of bytes determined by the function body size starting at the function address from the clean version of the DLL.

32. The methods of claim 22 wherein:
the API function is limited to Microsoft Windows rendering and drawing functions DrawText, DrawTextEx, TextOut, ExtTextOut and Microsoft Windows network socket functions WSASend and send in user mode and their counterparts in kernel mode with the clean version.

33. The methods of claim 22 further comprises,
protecting users from Spyware which sends a spy message to a spying application from an application using an operating system API function for sending messages by:
replacing an address of the operating system API function in the import and export tables in a PE file with an address of an Anti-spy function; and
intercepting and filtering out the spy message in the Anti-spy function.

34. The method of claim 22 further comprises performing Anti-spy procedures periodically.

35. The method of claim 22 further comprises:
invoking an Anti-spy procedure within a web browser by putting the Anti-spy procedure into a Browser helper object; and
providing a means for turning on and off an Anti-spy feature, wherein the means for turning on and off the anti-spy feature comprises at least one of a menu and a toolbar button.

36. The method of claim 22 further comprises alternatively:
invoking the Anti-spy feature as a standalone application; and
inserting an Anti-spy procedure into an Anti-spy DLL and loading the Anti-spy DLL into an application from where the Anti-spy DLL can be injected into other applications.

37. The method of claim 22 comprises:
treating the discovery of a tainted function address/value/body as an evidence of a presence of a Spyware; and
transmitting the discovery of the tainted function address/value/body to a scan based anti-spy software as a detection method.

38. A computerized method for dynamically protecting users from Spyware, comprising:
protecting users from Spyware which sends a spy message to a spying application from an application using an operating system API function for sending messages by:
replacing an address of the operating system API function in the import and export tables in a PE file with an address of an Anti-spy function.

39. The method in claim 38 wherein:
intercepting and filtering out the spy message in the Anti-spy function.

40. The method in claim 38 wherein:
the operating system API function comprises:
Microsoft Windows API SendMessage and PostMessage
